(19) United States
(12) Patent Application Publication
(10) Pub. No.: US 2003/0204041 A1
(43) Pub. Date: Oct. 30, 2003

(54) Ionic liquids

(76) Inventors: Hans-Josef Laas, Bergisch Gladbach (DE); Reinhard Halpaap, Odenthal (DE); Frank Richter, Leverkusen (DE); Jurgen Kocher, Langenfeld (DE)

Correspondence Address: BAYER POLYMERS LLC, 100 BAYER ROAD, PITTSBURGH, PA, 15205, US

(21) Appl. No.: 10/420,248

(22) Filed: Apr. 22, 2003

(30) Foreign Application Priority Data
Apr. 30, 2002 (DE) 10219227.8

(51) Int. Cl. C08G 18/22; C08G 18/16; C08G 18/18; C08G 18/08

(52) U.S. Cl. 528/51; 528/52

(57) ABSTRACT

The invention relates to novel ionic liquids, to a process for their preparation, and to their use as solvents or catalysts for chemical reactions, especially as catalysts for the oligomerisation of isocyanates.

### BACKGROUND OF THE INVENTION

The invention relates to novel ionic liquids, to a process for their preparation, and to their use as solvents or catalysts for chemical reactions, especially as catalysts for the oligomerisation of isocyanates.

Ionic liquids are generally understood as being liquids that consist solely of ions. In contrast to conventional salt melts, which are high-melting, highly viscous and very corrosive media, so-called ionic liquids are liquid and of comparatively low viscosity even at low temperatures, for example at temperatures below 100° C. Although the first examples were described as early as the beginning of the last century, the chemistry of ionic liquids has only been studied in greater detail for about 10 years. A detailed overview of the state of developments in the field of ionic liquids and their practical application as solvents in transition metal catalysis is to be found, for example, in Chem. Rev. 1999, 99, 2071-2083, Angew. Chem. 2000, 112, 3926-3945 or Nachr. Chem. 2001, 49, 12-16. Ionic liquids have not hitherto played a part in polyurethane chemistry.

The ionic liquids known today are based on a relatively comprehensible number of different structural components. As cations there are preferably used tetraalkylammonium, tetraalkylphosphonium, N-alkylpyridinium or 1,3-dialkylimidazolium ions, which are generally combined with anions such as, for example, chloride, chloroaluminate, trifluoromethanesulfonate (triflate), toluenesulfonate (tosylate), tetrafluoroborate, hexafluorophosphate or hexafluoroantimonate ions.

The object of the invention was to provide novel ionic liquids which can be used especially in polyurethane chemistry as solvents or catalysts, especially as catalysts for the oligomerisation of isocyanates.

### DESCRIPTION OF THE INVENTION

It has now, surprisingly, been found, salts consisting of particular ammonium and phosphonium cations and deprotonated five-membered-ring nitrogen heteroaromatic compounds as anions are chemically stable ionic liquids. Ionic liquids containing heterocyclic anions were not known hitherto. Not only can these novel ionic liquids be used as solvents for a large number of different (catalytic) reactions, but they are in themselves, surprisingly, also catalysts, especially highly active and highly selective catalysts, for the oligomerisation of isocyanates.

The present invention provides ionic liquids of the general formula (I)

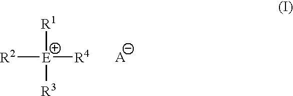

wherein

A^{⊖} represents an optionally substituted and/or fused five-membered nitrogen heteroaromatic compound which is deprotonated at a ring nitrogen,

E represents a nitrogen or phosphorus atom,

R¹, R², R³ and R⁴ represent identical or different radicals and each represents a moiety which contains up to 24 carbon atoms, which may contain up to 3 hetero atoms selected from the group consisting of oxygen, sulfur and nitrogen and which may be substituted by halogen atoms, said moiety being selected from the group consisting of a) saturated or unsaturated aliphatic radicals, b) saturated or unsaturated cycloaliphatic radicals, c) aromatic radicals and d) araliphatic radicals, with the proviso that at least one of the radicals R¹ to R⁴ represents an aliphatic radical having at least 6 carbon atoms.

The invention also provides a process for the preparation of those ionic liquids by i) deprotonating a five-membered, optionally substituted and/or fused nitrogen heteroaromatic compound A) containing a protonated ring nitrogen, with a metal base in the presence of a solvent to form a metal azolate

ii) reacting the metal azolate with a quaternary ammonium or phosphonium halide B) of the general formula (II)

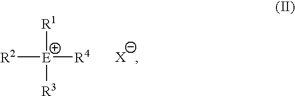

wherein

X^{⊖} represents a halogen atom selected from the group consisting of chlorine, bromine, iodine, and

E, R¹, R², R³ and R⁴ are as defined above for formula (I), and

iii) separating the metal halide that is formed and the solvent.

Finally, the invention relates also to the use of such ionic liquids as solvents and/or catalysts in chemical reactions, especially as catalysts for the oligomerisation of isocyanates.

Starting compounds A) for the preparation of the ionic liquids according to the invention are any desired five-membered nitrogen heteroaromatic compounds containing a protonated ring nitrogen, which compounds may optionally be substituted and/or fused and have a molecular weight of from 67 to 800, preferably from 67 to 650, particularly preferably from 67 to 500.

Such compounds are compounds of the general formulae (III) to (VIII) having a pyrrole (formula III), pyrazole (formula IV), imidazole (formula V), 1 ,2,4-triazole (formula VI), 1 ,2,3-triazole (formula VII) or tetrazole (formula VIII) basic framework, or their tautomeric structures,

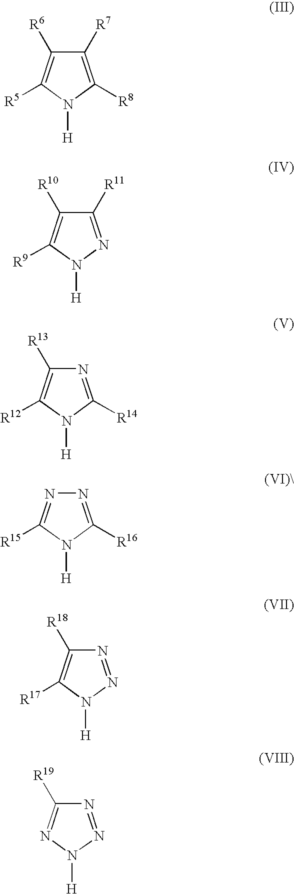

in which the radicals

R⁵ to R¹⁹ represent identical or different radicals and each represents a member selected from the group consisting a hydrogen atom, a fluorine atom, a chlorine atom, a bromine atom, a nitro group and moieties which contains up to 20 carbon atoms, which may contain up to 3 hetero atoms selected from the group consisting oxygen, sulfur and nitrogen and which may be substituted by halogen atoms or a nitro group, said moiety being selected from the group consisting of a) saturated or unsaturated aliphatic radicals, b) saturated or unsaturated cycloaliphatic radicals, c) aromatic radicals and d) araliphatic radicals, and wherein

R⁵ and R⁶, R⁶ and R⁷ and/or R⁷ and R⁸ in formula (III), R⁹ and R¹⁰ and/or R¹⁰ and R¹¹ in formula (IV), R¹² and R¹³ in formula (V) and R¹⁷ and R¹⁸ in formula (VII), also in combination with one another, together with the carbon atoms of the heterocyclic five-membered ring in question and optionally a further nitrogen atom or an oxygen atom, are able to form fused rings having from 3 to 6 carbon atoms, which compounds are then converted by reaction (deprotonation) with a metal base into the corresponding anions A^{⊖} of formulae (IX) to (XIV)

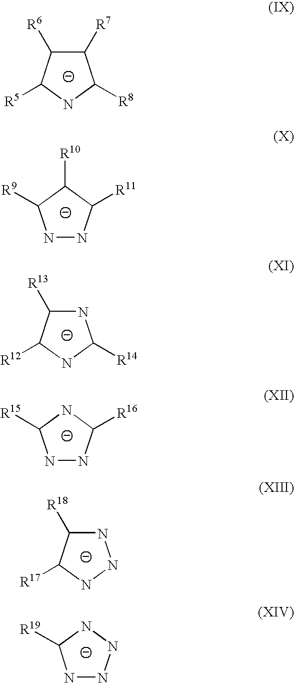

in which the radicals R⁵ to R¹⁹ are as defined in formulae (I) to (VIII).

Examples of suitable starting compounds A) which may be mentioned are pyrrole, indole, 4-methylindole, 5-methylindole, 6-methylindole, 2,3-dimethylindole, 2,5-dimethylindole, 5- and 6-chloroindole, 4-fluoroindole, 5-fluoroindole, 6-fluoroindole, 4-nitroindole, 5-nitro-2-phenylindole, 4-benzyloxyindole, 4-methoxyindole, 5-methoxyindole, 5,6-dimethoxyindole, 5-ethylindole, 7-ethylindole, 2-ethyl-3-methylindole, 5,6-(methylenedioxy)indole, carbazole, 3-chlorocarbazole, carboline, 3,4:5,6-dibenzocarbazole, pyrazole, 3-methylpyrazole, 4-methylpyrazole, 3,5-dimethylpyrazole, dimthylpyrazole, indazole, 3-methylindazole, 3-chiloroindazole, 4-chloroindazole, 4-nitroindazole, 5-nitroindazole, 3-chloro-5-nitroindazole, 3-chloro-6-nitroindazole, 4,5,6,7-tetrahydroindazole, imidazole, 2-methylimidazole, 4,5-dimethylimidazole, 4-nitroimidazole, 2-ethylimidazole, benzimidazole, 5-methyl-2-phenylbenzimidazole, 5-methoxybenzimidazole, purine, 6-methoxypurine, 1,2,3-triazole, benztriazole, 4-methylbenztriazole, 5-butylbenztriazole, 5- and 6-tolyl-triazole, 1,2,3-triazolo[4,5-b]pyridine, 5,6-dimethylbenzotriazole, 5-chloro-1,2,3-benztriazole, 1,2,4-triazole, 3-methyl-1,2,4-triazole, 5-methyl-1,2,4-triazole, 3,5-dimethyl-1,2,4-triazole, 3-nitro-1,2,4-triazole, 5-nitro-1,2,4-triazole, tetrazole, 5-methyltetrazole, 5-nitrotetrazole, 5-vinyltetrazole, 5-phenyltetrazole, 5-(methylmercapto)tetrazole, 5-(2-chlorphenyl)tetrazole, 5-(4-methylphenyl)tetrazole and 5-(3-nitrophenyl)tetrazole.

Preferred starting compounds A) are those having an imidazole (formula V), 1,2,4-triazole (formula VI) or 1,2,3-triazole (formula VII) basic framework. 1,2,4-Triazoles of the general formula (VI) are most especially preferred.

Starting compounds B) for the preparation of the ionic liquids according to the invention are any desired quaternary ammonium or phosphonium halides of the general formula (II)

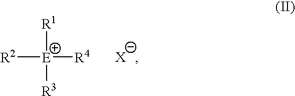

wherein

X^{⊖} represents a halogen atom from the group chlorine, bromine, iodine,

E represents a nitrogen or phosphorus atom, and

R¹, R², R³ and R⁴ represent identical or different radicals and each represents a moiety which contains up to 24 carbon atoms, which may contain up to 3 hetero atoms selected from the group consisting oxygen, sulfur and nitrogen and which may be substituted by halogen atoms, said moiety being selected from the group consisting of a) saturated or unsaturated aliphatic radicals, b) saturated or unsaturated cycloaliphatic radicals, c) aromatic radicals and d) araliphatic radicals, with the proviso that at least one of the radicals R¹ to R⁴ represents an aliphatic radical having at least 6 carbon atoms.

Suitable ammonium and phosphonium halides are, for example, methyltrioctylammonium chloride, ethylhexadecyidimethylammonium bromide, benzyldimethylhexadecylammonium chloride, benzyldimethylstearylammonium chloride, tetra-n-hexylammonium bromide, tetraheptylammonium bromide, tetrahexylammonium chloride, dodecyltrimethylammonium bromide, benzyldimethyldodecylammonium bromide, hexadecyltrimethylamrnonium bromide, hexadecyltrimethylammonium chloride, benzyldimethyltetradecylammonium chloride, tetra-n-octylammonium bromide, didecyldimethylammonium bromide, tetraoctadecylammonium bromide, didodecyldimethylammonium bromide, stearyltrimethylammonium bromide, trioctylpropylammonium chloride, n-nonyltrimethylammonium bromide, tetradodecylammonium bromide, tridodecylmethylammonium chloride, hexadecyltrioctadecylammonium bromide, stearyltrimethylammonium chloride, dimethyidistearylammonium chloride, didodecyldimethylammonium chloride, n-decyl-trimethylammonium chloride, n-octyltrimethylammonium chloride, dodecylyldimethylnaphthylammonium chloride, stearyltrioctylphosphonium iodide, tetra-n-octylammonium iodide, hexadecyltriethylammonium bromide, dimethyidipalmitylammonium bromide, dimethyidimyristylammonium bromide, tetradecyltributylphosphonium chloride, tetradecyltrihexylphosphonium chloride, hexadecyltributyl-phosphonium bromide, stearyltributylphosphonium bromide, ethyltri-n-octylphosphonium bromide, tetra-n-octylphosphonium bromide, n-octyltriphenylphosphonium chloride and dodecyltriphenylphosphonium bromide.

Preferred starting compounds B) are quaternary ammonium or phosphonium halides of the general formula (II) in which

R¹, R², R³ and R⁴ represent identical or different radicals and each represents a saturated aliphatic radical which may contain up to 18 carbon atoms and optionally up to 3 hetero atoms from the group oxygen, sulfur, nitrogen and may optionally be substituted by halogen atoms, with the proviso that at least one of the radicals R¹ to R⁴ represents an aliphatic radical having at least 6 carbon atoms.

Very particular preference is given to quaternary ammonium or phosphonium halides of the general formula (II) in which

R¹, R², R³ and R⁴ represent identical or different radicals and each represents a saturated aliphatic radical having up to 18 carbon atoms, with the proviso that at least two of the radicals R¹ to R⁴ have at least 6 carbon atoms.

The process according to the invention is generally carried out in the presence of a suitable solvent. Examples of suitable solvents are monohydric or polyhydric simple alcohols, such as, for example, methanol, ethanol, n-propanol, isopropanol, n-butanol, n-hexanol, 2-ethyl-1-hexanol, ethylene glycol, propylene glycol, the butanediol isomers, 2-ethyl-1,3-hexanediol or glycerol; ether alcohols, such as, for example, 1-methoxy-2-propanol, 3-ethyl-3-hydroxymethyloxetan, tetrahydrofurfuryl alcohol, ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, diethylene glycol or dipropylene glycol, but also solvents such as hexane, toluene, xylene, chlorobenzene, ethyl acetate, butyl acetate, diethylene glycol dimethyl ether, dipropylene glycol dimethyl ether, ethylene glycol monomethyl or monoethyl ether acetate, diethylene glycol ethyl and butyl ether acetate, propylene glycol monomethyl ether acetate, 1-methoxypropyl-2-acetate, 3-methoxy-n-butylacetate, propylene glycol diacetate, acetone, methyl ethyl ketone, methyl isobutyl ketone, cyclohexanone, N-methylpyrrolidone and N-methylcaprolactam or mixtures of such solvents. Preferred solvents are simple monoalcohols of the mentioned type having from 1 to 4 carbon atoms.

In the process according to the invention, the deprotonation of the starting compounds A) is carried out using conventional metal bases known from preparative organic chemistry, preferably alkali metal or alkaline earth metal bases, such as, for example, metal hydroxides, alcoholates, amides or hydrides. Examples of such bases are sodium methoxide, sodium ethoxide, potassium tert-butoxide, lithium diisopropylamide, sodium bis(trimethylsilyl)amide or sodium hydride. Preferred metal bases are alkali metal alcoholates, which are generally used in solution in the corresponding alcohols. The mentioned metal bases are generally used in the process according to the invention in an equimolar amount, based on the amount of five-membered ring heterocycle A) that is used.

For carrying out the process according to the invention, the starting compounds A) are dissolved, optionally under an inert gas atmosphere, in a solvent of the type mentioned by way of example above and are deprotonated at a temperature of, for example, from −20 to +80° C., preferably from −10 to +60° C., particularly preferably from 0 to +40° C., with a metal base of the above-mentioned type to form the corresponding metal azolates. In another form of the process according to the invention, it is possible to use, instead of the metal azolate solutions so prepared, the frequently commercially available metal salts, preferably alkali metal salts, such as, for example, Na salts, of the starting compounds A) in solution in a suitable solvent. Irrespective of the method used to prepare the metal azolate solutions, the starting compounds B), preferably likewise in dissolved form in one of the solvents mentioned by way of example above, are then added, while the above-mentioned temperature range is maintained, whereupon a metal/halide replacement generally begins spontaneously. The metal halide that precipitates thereby is separated off, for example by filtration, and the product according to the invention is finally freed of solvent in vacuo at a temperature of, for example, from 20 to 120° C., preferably from 30 to 100° C., particularly preferably from 40 to 80° C., preferably in a thin-layer evaporator.

The ionic liquids according to the invention are obtained in that manner with residual organic solvent contents of less than 5 wt. %, preferably less than 2 wt. %, most particularly preferably less than 1 wt. %. They have melting points below 100° C., preferably below 60° C., particularly preferably below 40° C., and viscosities in the molten state of less than 3000 mPas, preferably less than 2000 mPas, particularly preferably less than 1000 mPas.

The ionic liquids according to the invention are excellently suitable as solvents for a large number of different (catalytic) reactions. In addition, they are highly active and highly selective catalysts for the oligomerisation of isocyanates, especially for the preparation of polyisocyanates having a uretdione, isocyanurate and/or iminooxadiazinedione structure, and can advantageously be used as liquid compounds in solvent-free form.

### EXAMPLES

### Example 1

Methyltrioctylammonium 1,2,4-triazolate

180 g of a 30% methanolic sodium methanolate solution, corresponding to 1.0 mol of sodium methanolate, are placed at room temperature, under dry nitrogen, in a three-necked-flask stirring apparatus having a mechanical stirrer, an internal thermometer and a reflux condenser. A solution of 69 g (1.0 mol) of 1,2,4-triazole in 200 ml of methanol is added dropwise in the course of 45 minutes, and the reaction mixture is then stirred for 12 hours. A solution of 403 g (1.0 mol) of methyltrioctylammonium chloride (Aliquat® 336) in 45 g of methanol is then added dropwise in the course of one hour. Sodium chloride begins to precipitate immediately after the start of the ammonium salt addition. The reaction mixture is stirred overnight at room temperature, the precipitated sodium chloride is filtered off, and the solvent is then removed by distillation in a commercial thin-layer evaporator at a temperature of 40° C. and a pressure of about 1 mbar. The residue is filtered again, yielding 407.5 g (yield: 93.5%) of methyltrioctylammonium 1,2,4-triazolate in the form of a clear, almost colourless liquid having a viscosity of 665 mPas (23° C.) and a refractive index n_{D}²⁰ of 1.4751. The residual methanol content is 0.3 wt. %.

### Example 2

Methyltrioctylammonium 1,2,4-triazolate

91 g (1.0 mol) of sodium 1,2,4-triazolate are dissolved at room temperature, under dry nitrogen, in 250 ml of methanol in a three-necked-flask stirring apparatus having a mechanical stirrer, an internal thermometer and a reflux condenser. A solution of 403 g (1.0 mol) of methyltrioctylammonium chloride (Aliquat® 336) in 45 g of methanol is then added dropwise in the course of one hour, likewise at room temperature. Sodium chloride begins to precipitate immediately after the start of the ammonium salt addition. The reaction mixture is stirred overnight at room temperature and is worked up as described in Example 1. 393 g (yield: 90.1%) of methyltrioctylammonium 1,2,4-triazolate are obtained in the form of a clear, almost colourless liquid having a viscosity of 670 mPas (23° C.) and a refractive index n_{D}²⁰ of 1.4751. The residual methanol content is 0.3 wt. %.

### Example 3

Trihexyltetradecylphosphonium 1,2,4-triazolate

According to the process described in Example 1, 180 g of a 30% methanolic sodium methanolate solution, corresponding to 1.0 mol of sodium methanolate, are reacted with 69 g (1.0 mol) of 1,2,4-triazole dissolved in 200 ml of methanol and 518 g (1.0 mol) of trihexyltetradecylphosphonium chloride (Cyphos® 3653, Cytec Industries) dissolved in 60 g of methanol. After filtration, thin-layer distillation at a temperature of 50° C. and a pressure of 0.3 mbar, and further filtration, 510 g (yield: 92.6%) of trihexyltetradecylphosphonium 1,2,4-triazolate are obtained in the form of a clear, almost colourless liquid having a viscosity of 570 mPas (23° C.) and a refractive index n_{D}²⁰ of 1.4821. The residual methanol content is 0.1 wt. %.

### Example 4

Trihexyltetradecylphosphonium imidazolate

According to the process described in Example 1, 180 g of a 30% methanolic sodium methanolate solution, corresponding to 1.0 mol of sodium methanolate, are reacted with 68 g (1.0 mol) of imidazole dissolved in 200 ml of methanol and 518 g (1.0 mol) of trihexyltetradecylphosphonium chloride (Cyphos® 3653, Cytec Industries) dissolved in 60 g of methanol. After filtration, thin-layer distillation at 50° C. and 0.3 mbar, and further filtration, 494 g (yield: 89.8%) of trihexyltetradecylphosphonium imidazolate are obtained in the form of a clear, light-yellow liquid having a viscosity of 295 mPas (23° C.) and a refractive index n_{D}²⁰ of 1.4760. The residual methanol content is 0.1 wt. %.

### Example 5

Use as Oligomerisation Catalyst for Isocyanates

1000 g (4.50 mol) of 1-isocyanato-3,3,5-trimethyl-5-isocyanatomethylcyclohexane (isophorone diisocyanate; IPDI) are degassed for one hour in vacuo (2 mbar) and then aerated with dry nitrogen and heated to 40° C. 0.8 g (1.8 mmol) of the methyl-trioctylammonium 1,2,4-triazolate prepared according to Example 1 are added, with stirring, the reaction mixture warming to about 42° C. as a result of the heat of reaction that is liberated. After a reaction time of 45 minutes, during which the heat of reaction subsides again, the NCO content in the reaction mixture is 29.7%, corresponding to a degree of oligomerisation of 21.4%. 0.38 g (1.8 mmol) of dibutyl phosphate is added in order to stop the reaction, and the excess monomeric diisocyanate is distilled off by means of a thin-layer evaporator at a temperature of 160° C. and a pressure of 0.3 mbar. A highly viscous, almost colorless uretdione polyisocyanate having a free NCO group content of 16.9% and a monomeric IPDI content of 0.3% is obtained.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. An ionic liquid of the general formula (I) 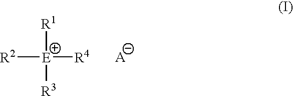
wherein
A^{⊖} represents an optionally substituted and/or fused five-membered nitrogen heteroaromatic compound which is deprotonated at a ring nitrogen,
E represents a nitrogen or phosphorus atom,
R¹, R², R³ and R⁴ represent identical or different radicals and each represents a moiety which contains up to 24 carbon atoms, which may contain up to 3 hetero atoms selected from the group consisting oxygen, sulfur and nitrogen and which may be substituted by halogen atoms, said moiety being selected from the group consisting of a) saturated or unsaturated aliphatic radicals, b) saturated or unsaturated cycloaliphatic radicals, c) aromatic radicals and d) araliphatic radicals, with the proviso that at least one of the radicals R¹ to R⁴ represents an aliphatic radical having at least 6 carbon atoms.

2. A process for the preparation of an ionic liquid comprising:
i) deprotonating a five-membered, optionally substituted and/or fused nitrogen heteroaromatic compound A) containing a protonated ring nitrogen, with a metal base in the presence of a solvent to form a metal azolate
ii) reacting the metal azolate with a quaternary ammonium or phosphonium halide B) of the general formula (II) 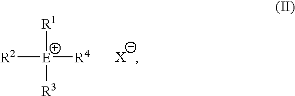
wherein
X^{⊖} represents a halogen atom selected from the group consisting of chlorine, bromine, iodine, and
E represents a nitrogen or phosphorus atom,
R¹, R², R³ and R⁴ represent identical or different radicals and each represents a moiety which contains up to 24 carbon atoms, which may contain up to 3 hetero atoms selected from the group consisting of oxygen, sulfur and nitrogen and which may be substituted by halogen atoms, said moiety being selected from the group consisting of a) saturated or unsaturated aliphatic radicals, b) saturated or unsaturated cycloaliphatic radicals, c) aromatic radicals and d) araliphatic radicals, with the proviso that at least one of the radicals R¹ to R⁴ represents an aliphatic radical having at least 6 carbon atoms, and
iii) separating the metal halide that is formed and the solvent.

3. In a process for the oligomerisation of an isocyanate in the presence of a catalyst, the improvement wherein the catalyst is the ionic liquid of claim 1.
